(19) United States
(12) Patent Application Publication
(10) Pub. No.: US 2020/0123779 A1
(43) Pub. Date: Apr. 23, 2020

(54) GUTTER CLEANING DEVICE

(71) Applicant: Tommie MOORE, CHICAGO, IL (US)

(72) Inventor: Tommie MOORE, CHICAGO, IL (US)

(21) Appl. No.: 15/770,390

(22) PCT Filed: Nov. 14, 2016
(86) PCT No.: PCT/US2016/061896

§ 371 Date: Apr. 23, 2018

(51) Int. Cl. E04D 13/076; B08B 9/032

(52) U.S. Cl. CPC E04D 13/0765; B08B 2209/032; B08B 9/0321

(57) ABSTRACT

A gutter cleaning device designed to allow a user to spray water into a gutter and thereby clean debris therefrom, comprising: an extender, extending vertically above a head of a user, and designed to allow the user to elevate a working end of the cleaning device; and a working end of the gutter cleaning device, having: a water hose coupling device, designed to couple to a water hose; an angled ridged tube, coupled to the water hose coupling device; a working end coupler, coupled to the extender to the working end, a horizontal ridged tube designed to hang over a lip of a gutter, an elbow, for routing water toward the gutter, and a flexible water nozzle, designed with an angled edge.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

### (1) Field of the Invention

This invention relates generally to the field of gutter cleaning and more particularly to a system and method for remove debris from a gutter system built around a roof of a building using a common garden house and water ejected therefrom.

### (2) Background of the Invention

In many locations throughout the world, organic debris such as deciduous leaves, pine needles & moss present a continuous source of material that falls upon the roofs of houses. Such material ultimately is transported via wind and rain into the gutters causing damage to their structure and requiring continuous maintenance of the system. Presently there are 3 distinct methods for eliminating accumulated debris. One method employs screens or permeable drain covers. Though this method usually requires little upkeep once installed, these covers merely act as a ramp to transfer the debris onto shrubbery, walkways and flowerbeds. And even permeable covers become clogged and periodically require removal and cleaning.

The second approach involves intrusive sub-systems that are difficult to install or retrofit. Besides the extensive labor of installing, none of them are compatible with the large variety of shapes that are presently in use.

The third method of maintenance involves the use of some form of tool, usually, manual, but sometimes semi-automatic. Over the years the need for maintaining rain gutter systems has spawned a diverse array of gadgets, none of which provided an effective solution.

Cleaning gutters using present technologies is not only an arduous and time consuming task, but also a potentially dangerous one. None of the available products allow a person to effectively clean a gutter from ground level. Therefore a person must either climb a ladder, or access the gutter by crawling along the roof. Both of these methods are potentially hazardous to one's health as well as to one's property.

Even “professional gutter cleaners” are prone to these inherent dangers. Many of the tools, sub-systems or permeable covers that are available are not only inefficient at solving the problem, but often they are self-defeating or cause new problems.

Numerous and sundry hand tools have been proposed for manually cleaning rain gutters. Many of these tools are only functional only if a person is stationed at roof level. This means that access to the gutter must either be accomplished by crawling along the cave of the roof or by positioning oneself atop a ladder or other elevated pedestal. Besides the inherent danger of such orientation, there is usually a great deal of difficulty negotiating shrubbery, fences and flower gardens. Soil that is directly adjacent to structures is notorious for being unstable in texture and therefore difficult to achieve a firm footing for a ladder. This not only invites the possibility of personal injury by the ladder toppling onto the ground; but there is also a good chance that a person will damage the gutter structure either by leaning the ladder against it or grasping the gutter to retain ones balance.

The majority of tools designed to be operated at roof level do not facilitate the use of water because of the difficulty of manipulating an attached hose in such a. precarious position.

Cleaning debris from gutters also necessitates disposal of such debris. People who clean their gutters from roof level usually do not like to see the debris discarded haphazardly on to the walkways and shrubbery below them.

Therefore some procedure must be incorporated to enable collection of the debris for transportation elsewhere. It is not uncommon in heavily wooded parts of the world for gutters to accumulate in excess of one hundred pounds of debris annually. Translated into volume this entails a sizeable amount to be transported.

Whether a person uses a trash bag, wheelbarrow, bucket or any other similar container, the job is very inconvenient. If one uses a ladder, it must be picked up and re-stabilized after cleaning approximately four feet of the gutter. The wheelbarrow or container must also be moved. If one is accessing the gutter by crawling along the cave the job is probably no easier or safer. Even if one is not injured seriously, he or she can count on sore muscles, knees and hands once the job is done. Besides the danger and cumbersomeness of this form of gutter maintenance one can also add the messiness that leaves both body and clothes dirty and worn.

Several tools have been proposed that attempt to solve the above problems by a tool that can access the roof gutter by a person standing on the ground. Accordingly, various prior arts have disclosed such related inventions, whereby the following patents are herein incorporated by reference for their supportive teachings, in which:

U.S. Pat. No.: 4,319,851, issued Mar. 16, 1982, to Arthur, discloses a device for cleaning rain gutters.

U.S. Pat. No.: 5,386,942, issued Feb. 7, 1995, to Dietle, discloses a roof gutter and downspout cleaner.

U.S. Pat. No.: 5,727,580, to Patterson, issued Mar. 17, 1998, discloses a gutter cleaner system.

U.S. Pat. No.: 7,549,191, to Seasholtz et al., issued June 23,2009, disclose a gutter cleaning blower vacuum attachment apparatus.

U.S. Pat. No.: 8,409,365, to Cox, issued Apr. 2, 2013, discloses a gutter cleaning device.

U.S. Pat. No.: 3,041,655, issued Jul. 3, 1962, to W. H. Entler et al. teaches of an eves gutter cleaning device.

U.S. Pat. No.: 9,428,914, issued Aug. 30, 2016, to Partis, Jr., teaches of a gutter cleaning device.

### SUMMARY

In view of the foregoing disadvantages inherent in the known types of apparatus to degrade pollution percent or like in the prior art, the present invention provides an improved apparatus to degrade the percentage of pollution that enters into atmosphere that forces factory smoke to enter into treatment cylinder provided with mist systems to treat such waste gas. As such, the general purpose of the present invention, which will be described subsequently in greater detail, is to provide a new and improved perfume applicator with all the advantages of the prior art and none of the disadvantages.

Accordingly, it is an object of the present invention to provide a gutter cleaning device designed to allow a user to spray water into a gutter and thereby clean debris therefrom, comprising: an extender, extending vertically above a head of a user, and designed to allow the user to elevate a working end of the cleaning device; and a working end of the gutter cleaning device, having: a water hose coupling device, designed to couple to a water hose; an angled ridged tube, coupled to the water hose coupling device; a working end coupler, coupled to the extender to the working end, a horizontal ridged tube designed to hang over a lip of a gutter, an elbow, for routing water toward the gutter, and a flexible water nozzle, designed with an angled edge.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is perspective view of the present invention.

FIG. 2 is a side view of the present invention.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

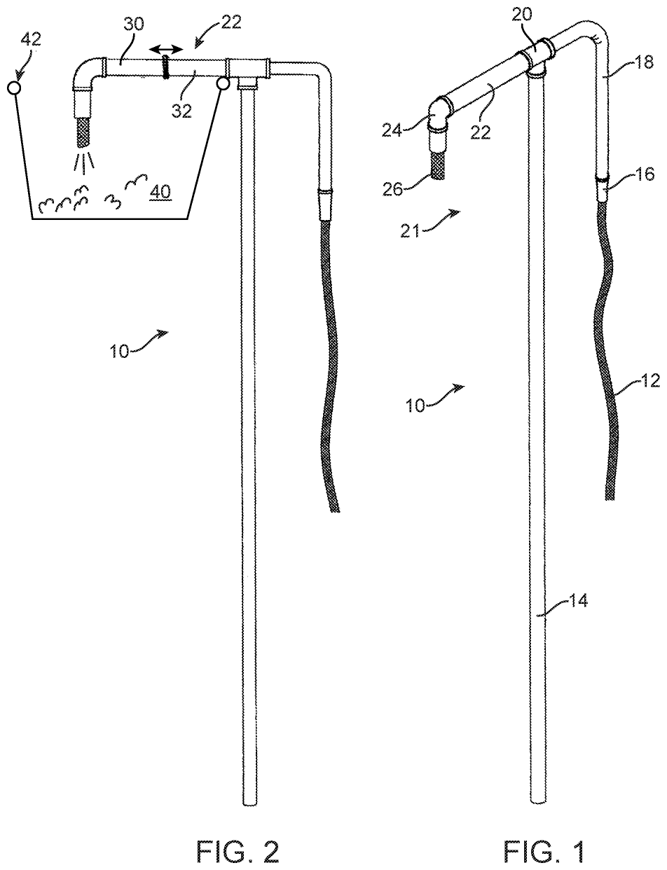

Turning now to FIGS. 1 and 2, the present invention discloses a perspective view of the gutter-cleaning device 10. Specifically, there is a water hose 12 for routing water thereto the cleaning device 10. There is an extender 14, used to allow a user (not shown) to elevate the working end of the cleaning device. The working end 21 consists of a water house coupling device 16, an angled ridged tube 18, a working end coupler 20 for coupling the extender 14 to the working end 21, a horizontal ridged tube for hanging over a lip 42 of a gutter 40, an elbow 24, for routing water downward into the gutter, and a flexible water nozzle 26, designed with an angled cut edge as shown, and is made of flexible material to allow for malleability of it during making contact with a bottom of a gutter 40.

It is noted that the horizontal ridged tube 22 may be specifically designed to create the exact spacing needed to extend the nozzle 26 to a central portion of a gutter. Whereby, the extender 14 may be designed to rub against an outside edge of the gutter and thus align the nozzle to a central region of the gutter.

Referring now more particularly to FIG. 2, there is illustrated another embodiment of the invention that may be implemented. Specifically, there is illustrate a modification to the horizontal ridged tube 22, whereby there are illustrated the use of a first and second horizontal ridged tubes 30 and 32, whereby one of the tubes is smaller and will slide in and out of the larger tube thus allowing for an adjustment of the overall length of the distance between the extender 14 and the nozzle 26, to allow for a more precise adjustment of the nozzle 26 to spray water into the central region of the gutter 40.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptions or variations of the present invention.

Although the invention has been explained in relation to its preferred embodiment, it is to be understood that many other possible modifications and variations can be made without departing from the spirit and scope of the invention.

I/we claim:

1. A gutter cleaning device designed to allow a user to spray water into a gutter and thereby clean debris therefrom, comprising:
a. an extender, extending vertically above a head of a user, and designed to allow the user to elevate a working end of the cleaning device;
b. a working end of the gutter cleaning device, having:
I. a water hose coupling device, designed to couple to a water hose;
II. an angled ridged tube, coupled to the water hose coupling device;
III. a working end coupler, coupled to the extender to the working end,
IV. a horizontal ridged tube designed to hang over a lip of a gutter,
V. an elbow, for routing water toward the gutter, and
VI. a flexible water nozzle, designed with an angled edge.

2. The gutter cleaning device of claim 1, wherein the horizontal ridged tube includes a first and second horizontal ridged tubes, whereby the first tubes is smaller in diameter than the second tube, thus allowing for an adjustment of an overall length of a distance between the extender and the nozzle, to allow for a more precise adjustment of the nozzle to spray water into a central region of the gutter.
